(19) United States
(12) Patent Application Publication
(10) Pub. No.: US 2026/0364576 A1
(43) Pub. Date: Nov. 19, 2026

(54) IN-SITU TREATMENT OF A FISCHER-TROPSCH CATALYST

(71) Applicant: BP P.L.C., London (GB)

(72) Inventor: Alexander James Paterson, London (GB)

(21) Appl. No.: 19/133,630

(22) PCT Filed: Dec. 1, 2023
(86) PCT No.: PCT/IB2023/062142

§ 371 Date: May 28, 2025

(30) Foreign Application Priority Data
Dec. 2, 2022 (EP) 22211100.7
Dec. 2, 2022 (EP) 22211105.6
Dec. 2, 2022 (EP) 22211242.7
Dec. 2, 2022 (EP) 22211252.6
Dec. 2, 2022 (EP) 22211255.9
Dec. 2, 2022 (EP) 22211256.7
Dec. 2, 2022 (EP) 22211257.5

(51) Int. Cl. B01J 23/89; B01J 23/889; B01J 37/18; C10G 2/00

(52) U.S. Cl. CPC B01J 23/8913; B01J 23/8892; B01J 23/8896; B01J 37/18; C10G 2/332; C10G 2/333

(57) ABSTRACT

A process for converting a mixture of hydrogen and carbon monoxide to a hydrocarbon composition comprising one or more optionally oxygenated hydrocarbons, the process comprising the following steps: (a) providing a catalyst material comprising cobalt disposed on a support; (b) reducing the catalyst material at a temperature of below 300 °C to form the first activated catalyst; (c) contacting the first activated catalyst with a mixture of hydrogen and carbon monoxide at a first reaction temperature (T_{R}1) of at least 180 °C and first reaction pressure (P_{R}1) of at least 10 bara to produce hydrocarbons for a first reaction time period of at least 24 hours; (d) after the first reaction time period, contacting the first activated catalyst with a carbon monoxide rich stream at a first pressure (P1) and a first temperature (T1) to provide a treated catalyst, wherein P1 is at least 1 bara and at most 50 bara, and Tl is at most 300 °C; (e) contacting the treated catalyst with a hydrogen rich stream at a second temperature (T2) and a second pressure (P2) to form a second activated catalyst, wherein P2 is at least 10 bara and wherein T2 is less than 300 °C; and (f) contacting the second activated catalyst with a mixture of hydrogen and carbon monoxide at a second reaction temperature (T_{R}2) of at least 180 °C and second reaction pressure (P_{R}2) of at least 10 bara to produce hydrocarbons.

### CROSS-REFERENCE TO RELATED APPLICATIONS

This application claims the benefit of priority of European Patent Application no. 22211255.9, filed 2 Dec. 2022, European Patent Application no. 22211252.6, filed 2 Dec. 2022, European Patent Application no. 22211242.7, filed 2 Dec. 2022, European Patent Application no. 22211105.6, filed 2 Dec. 2022, European Patent Application no. 22211100.7, filed 2 Dec. 2022, European Patent Application no. 22211257.5, filed 2 Dec. 2022, and European Patent Application no. 22211256.7, filed 2 Dec. 2022, each of which is hereby incorporated herein by reference in its entirety.

### BACKGROUND OF THE DISCLOSURE

### Field

The present disclosure relates to a process for treating a Fischer-Tropsch catalyst during a Fischer-Tropsch process, and a method of improving at least one aspect of the performance of a Fischer-Tropsch catalyst.

### Technical Background

The conversion of synthesis gas into hydrocarbons by the Fischer-Tropsch process has been known for many years. The growing importance of alternative energy sources has resulted in renewed interest in the Fischer-Tropsch (FT) process as it allows a direct and environmentally acceptable route to high-quality fuels and feedstock chemicals.

FT processes are known for producing linear hydrocarbons for use in fuels, as well as oxygenates which serve as valuable feedstock chemicals. The hydrocarbon fuel deriving from FT processes is better able to meet increasingly stringent environmental regulations compared to conventional refinery-produced fuels, as FT-derived fuels typically have lower contents of sulfur, nitrogen, and aromatic compounds which contribute to the emission of potent pollutants such as SO₂, NOₓ, and particulates. Alcohols derived from FT processes often have a higher-octane rating than hydrocarbons and thus burn more completely, thereby reducing the environmental impact of such a fuel. Alcohols and other oxygenates obtained may also be used as reagents in other processes, such as in the synthesis of lubricants.

A variety of transition metals have been identified to be catalytically active in the conversion of synthesis gas into hydrocarbons and oxygenated derivatives thereof. In particular, cobalt, nickel, ruthenium and iron have been studied, often in combination with a support material, of which the most common are alumina, silica and carbon.

In the typical preparation of supported cobalt-containing FT synthesis catalysts, a solid support material is contacted with a solution of a soluble cobalt compound, such as cobalt nitrate. The impregnated support is subsequently calcined and/or oxidized to form a cobalt oxide, typically one or more of CoO, Co₂O₃, or Co₃O₄. However, such oxides typically have poor FT catalytic activity and must be reduced to form the preferred catalytically active species of cobalt metal.

Subjecting Fischer-Tropsch catalyst to controlled treatments and conditions, such as the process by which the FT catalyst is activated, are known to have an impact on the performance of the Fischer-Tropsch synthesis reaction and as such is typically performed under conditions which are different to the conditions of the Fischer-Tropsch synthesis reaction.

Accordingly, there exists a need to develop new methods of treating FT catalysts.

### SUMMARY

The inventors have found an in-situ treatment of a Fischer-Tropsch catalyst which can be performed during the operation of a Fischer-Tropsch synthesis reaction which can result in the improvement of at least one aspect of the performance of a Fischer-Tropsch catalyst.

Thus, in one aspect, the present disclosure provides a process for converting a mixture of hydrogen and carbon monoxide to a hydrocarbon composition comprising one or more optionally oxygenated hydrocarbons, the process comprising the following steps:
(a) providing a catalyst material comprising cobalt disposed on a support;
(b) reducing the catalyst material at a temperature of below 300 °C to form the first activated catalyst;
(c) contacting the first activated catalyst with a mixture of hydrogen and carbon monoxide at a first reaction temperature (T_{R}1) of at least 180 °C and first reaction pressure (P_{R}1) of at least 10 bara to produce hydrocarbons for a first reaction time period of at least 24 hours;
(d) after the first reaction time period, contacting the first activated catalyst with a carbon monoxide rich stream at a first pressure (P1) and a first temperature (T1) to provide a treated catalyst, wherein P1 is at least 1 bara and at most 50 bara, and T1 is at most 300 °C;
(e) contacting the treated catalyst with a hydrogen rich stream at a second temperature (T2) and a second pressure (P2) to form a second activated catalyst, wherein P2 is at least 10 bara and wherein T2 is less than 300 °C; and
(f) contacting the second activated catalyst with a mixture of hydrogen and carbon monoxide at a second reaction temperature (T_{R}2) of at least 180 °C and second reaction pressure (P_{R}2) of at least 10 bara to produce hydrocarbons.

Another aspect of the present disclosure is the use of an in-situ catalyst treatment process as described herein to increase the selectivity of the conversion of carbon monoxide and hydrogen to hydrocarbons having five or more carbon atoms (C5+), compared to a catalyst which has not been subjected to such an in-situ treatment.

Another aspect of the present disclosure is the use of an in-situ catalyst treatment process as described herein to increase the conversion of carbon monoxide and hydrogen to hydrocarbons compared to a catalyst which has not been subjected to such an in-situ treatment.

Another aspect of the present disclosure is the use of an in-situ catalyst treatment process as described herein to increase the catalyst life of the catalyst.

Other aspects of the disclosure will be apparent to those skilled in the art in view of the description that follows.

### DETAILED DESCRIPTION

The present disclosure is concerned with the Fischer-Tropsch synthesis process and processes to improve the performance of Fischer-Tropsch synthesis processes using cobalt-based catalysts.

The present inventors have found that in-situ treatment of an activated cobalt-containing catalyst material with a carbon monoxide rich stream can form cobalt carbides, and that subsequently treating the cobalt carbide containing catalyst material with a hydrogen rich stream can then be used in the conversion of hydrogen and carbon monoxide to hydrocarbon compositions. It has surprisingly been found by the inventors that performing such an in-situ treatment after the catalyst has been subjected to a period of hydrocarbon synthesis can have a significant impact on the performance of the catalyst in the Fischer-Tropsch synthesis reaction.

Cobalt metal as commonly formed in an activated form of a Fischer-Tropsch catalyst material (e.g., from reduction from cobalt oxide) is typically made up of a mixture of two metallic phases: hexagonal close-packed (hcp) cobalt and face-centered cubic (fcc) cobalt. As the energy difference between these two phases is small, both phases are typically present in substantial amounts. The present inventors have noted that hcp cobalt is more active for FT processes than the typical mixed-phase cobalt. See, e.g., Journal of Catalysis 277, 14-26 (2011). Advantageously, reduction of the cobalt carbide-based passivated catalyst surprisingly generates a catalyst that includes cobalt metal almost exclusively in the hcp phase.

Accordingly, one aspect of the disclosure provides a process for converting a mixture of hydrogen and carbon monoxide to a hydrocarbon composition comprising one or more optionally oxygenated hydrocarbons, the process comprising the following steps:
(a) providing a catalyst material comprising cobalt disposed on a support;
(b) reducing the catalyst material at a temperature of below 300 °C to form the first activated catalyst;
(c) contacting the first activated catalyst with a mixture of hydrogen and carbon monoxide at a first reaction temperature (T_{R}1) of at least 180 °C and first reaction pressure (P_{R}1) of at least 10 bara to produce hydrocarbons for a first reaction time period of at least 24 hours;
(d) after the first reaction time period, contacting the first activated catalyst with a carbon monoxide rich stream at a first pressure (P1) and a first temperature (T1) to provide a treated catalyst, wherein P1 is at least 1 bara and at most 50 bara, and T1 is at most 300 °C;
(e) contacting the treated catalyst with a hydrogen rich stream at a second temperature (T2) and a second pressure (P2) to form a second activated catalyst, wherein P2 is at least 10 bara and wherein T2 is less than 300 °C; and
(f) contacting the second activated catalyst with a mixture of hydrogen and carbon monoxide at a second reaction temperature (T_{R}2) of at least 180 °C and second reaction pressure (P_{R}2) of at least 10 bara to produce hydrocarbons.

The catalyst material described herein include cobalt, in various forms, a support, and optionally other metals or reaction modifiers. Supported cobalt-based materials are well-known in the art, and can generally be adapted for use in the processes and materials described herein.

In certain embodiments as otherwise described herein, the catalyst material as described herein include cobalt in the range of 5 wt % to 35 wt %, on an elemental basis. For example, in certain embodiments as otherwise described herein, cobalt may be present in the range of 7-35 wt %, or 10-35 wt %, or 5-25 wt %, or 7-25 wt %, or 10-25 wt %, or 5-20 wt %, or 7-20 wt %, or 10-20 wt %.

The catalyst material as described herein can include other metal species, e.g., as promoters. For example, in certain embodiments as otherwise described herein, a catalyst material includes manganese, for example, in an amount in a range of up to 15 wt %, e.g., up to 12 wt %, or up to 10 wt %, or up to 7 wt %, or up to 5 wt %, or up to 3 wt %, or up to 2 wt %, on an elemental basis; typically, when manganese is present, it would be present in an amount of at least 0.1 wt %, or at least 0.2 wt %, or at least 0.3 wt %, or at least 0.5 wt %, or at least 0.5 wt %, on an elemental basis. In certain such embodiments, a catalyst material includes manganese in an amount in the range of 0.1-15 wt %, e.g., 0.2-15 wt %, or 0.3-15 wt %, or 0.4-15 wt %, or 0.5-15 wt %, or 0.1-12 wt %, or 0.2-12 wt %, or 0.3-12 wt %, or 0.4-12 wt %, or 0.5-12 wt %, or 0.1-10 wt %, or 0.2-10 wt %, or 0.3-10 wt %, or 0.4-10 wt %, or 0.5-10 wt %, or 0.1-7 wt %, or 0.2-7 wt %, or 0.3-7 wt %, or 0.4-7 wt %, or 0.5-7 wt %, or 0.1-5 wt %, or 0.2-5 wt %, or 0.3-5 wt %, or 0.4-5 wt %, or 0.5-5 wt %, or 0.1-3 wt %, or 0.2-3 wt %, or 0.3-3 wt %, or 0.4-3 wt %, or 0.5-3 wt %, or 0.1-2 wt %, or 0.2-2 wt %, or 0.3-2 wt %, or 0.4-2 wt %, or 0.5-2 wt %. In some embodiments, manganese is present in relatively greater amounts, for example 2-15 wt %, e.g., 3-15 wt %, or 4-15 wt %, or 2-12 wt %, or 3-12 wt %, or 4-12 wt %, or 2-10 wt %, or 3-10 wt %, or 4-10 wt %, or 2-7 wt %, or 3-7 wt %, or 4-7 wt %. Of course, in other embodiments substantially no manganese is present (e.g., less than 0.1 wt % or less than 0.5 wt %) manganese is present. Other metals can be present, e.g., as promoters.

Various support materials are known in the art and may be selected based on the precise requirements of the FT reactor or other chemical, mechanical or economic requirements. In certain embodiments as otherwise described herein, the support comprises at least one of titanium oxide, zirconium oxide, cerium oxide, aluminum oxide, silicon oxide and zinc oxide. In particular embodiments, as otherwise described herein, the support comprises exactly one of titanium oxide, zirconium oxide, cerium oxide, aluminum oxide, silicon oxide and zinc oxide. In another particular embodiment, as otherwise described herein, the support comprises titanium oxide. In another particular embodiment, as otherwise described herein, the support is titanium oxide.

The catalyst material can be prepared using methods conventional in the art. In certain embodiments, the cobalt is introduced onto the support through the introduction of a solution containing a soluble cobalt salt (e.g., cobalt nitrate) to the support and the combination calcined and/or oxidized, rendering insoluble cobalt particles (e.g., as cobalt oxide) on the support. In certain embodiments, the catalyst material comprises the combination of the calcined metal (e.g., including calcined cobalt) adhered to the support. In particular embodiments, cobalt of the catalyst material (i.e., at least a portion of the cobalt, up to the entirety of the cobalt, for example, at least 50%, at least 75%, or at least 90%) is in the form of at least one of cobalt oxide and cobalt hydroxide. For example, the cobalt in the catalyst material may be cobalt oxide (e.g., CoO, Co₃O₄, or Co₂O₃, or a combination thereof) or cobalt hydroxide (e.g., Co(OH)₂ or Co(OH)₃ or a combination thereof), or a combination of cobalt oxide and cobalt hydroxide.

In certain embodiments of the present invention, the catalyst material may be reduced and passivated prior to loading into the reactor, in which case the catalyst material may comprise cobalt in a passivated form, for example it is passivated by converting at least a portion of the cobalt to be in the form of cobalt carbide or in the form cobalt oxide. In particular embodiments, the cobalt of the catalyst material is in a passivated form and comprises at least a portion in the form of cobalt carbide (i.e., at least a portion of the cobalt, up to the entirety of the cobalt, for example, at least 40%, at least 50%, or at least 60%). In other particular embodiments, the cobalt of the catalyst material is in a passivated form and comprises at least a portion in the form of cobalt oxide (i.e., for example at least 10% and at most 40% in the form of cobalt oxide). In some or all embodiments, the catalyst material comprises cobalt in the form of cobalt oxide or cobalt hydroxide or cobalt carbide, or a combination of two or more of cobalt oxide and cobalt hydroxide and cobalt carbide.

Following provision of the catalyst material, the cobalt species disposed thereon, e.g., comprising cobalt in the form of cobalt oxide(s)/hydroxide(s)/carbide(s) as described above, are substantially reduced to generate the first activated catalyst. This process results in at least portion of the cobalt being transformed into cobalt metal. Desirably, the reduction results in at least 50 mol % of the cobalt of the first activated catalyst being in the form of cobalt metal, e.g., at least 75 mol %, or at least 90 mol % of the cobalt being in the form of cobalt metal. For example, in particular embodiments, at least 95 mol % of the cobalt is in the form of cobalt metal. The person of ordinary skill in the art can use conventional methods to reduce the cobalt on the catalyst material to metallic form. In certain embodiments as otherwise described herein, the reduction of the cobalt on the catalyst material is performed using hydrogen gas, H₂, as the reducing agent. The hydrogen gas may be mixed with other gases, such as an inert carrier gas. Examples of such inert carrier gasses include nitrogen, carbon dioxide, argon, or helium. The hydrogen gas may also be mixed with carbon monoxide, with or without one or more additional carrier gasses. In certain embodiments, the reduction of the cobalt on the catalyst material is performed using a reducing agent which comprises carbon monoxide, wherein the carbon monoxide is present in an amount in the range of 0.1-10 vol %, e.g., 0.1-5 vol %, or 0.1-1 vol %. But in other embodiments, substantially no carbon monoxide is present (i.e., no more than 0.1 vol %). In certain embodiments, the reduction is effected by contacting the catalyst material with a reducing gas, wherein the reducing gas comprises at least 50 vol % H₂ (e.g., at least 60 vol %, or at least 70 vol %, or at least 80 vol %, or at least 90 vol %, or at least 95 vol %, or essentially 100 vol % H₂).

The reduction of the catalyst material to provide the first activated catalyst is performed at a temperature of below 300 °C. Suitable reduction temperatures would be known to a person skilled in the art. In certain embodiments as otherwise described herein, the reduction temperature is in the range of from 200 °C to below 300 °C, or in the range of from 210 °C to below 300 °C, or in the range of 210 °C to 290 °C, or in the range of 220 °C to below 300 °C, or in the range of 220 °C to 290 °C, or in the range of 220 °C to 280 °C, or in the range of 230 °C to 280 °C, or in the range of 240 °C to 280 °C. The reduction of the catalyst material to the first activated catalyst occurs at a suitable reduction pressure. Suitable reduction pressures would be known to a person skilled in the art. In certain embodiments as otherwise described herein, the reduction pressure is in the range of 0.5 bara to 5 bara, e.g., 0.7 bara to 3 bara. The reduction can be performed for a time (e.g., up to 48 hours, e.g., 2-48 hours or 8-30 hours) and under conditions sufficient to provide the desired degree of reduction as described above.

As described herein, the treatment of the catalyst material with the reducing gas produces an activated catalyst that includes cobalt as cobalt metal (for example, in an amount of at least 50 mol %, e.g., at least 75 mol %, or at least 90 mol %, or at least 95 mol % of the cobalt as described above).

As described herein, the reduction of the catalyst material produces a first activated catalyst that includes cobalt as cobalt metal (for example, in an amount of at least 50 mol %, e.g., at least 75 mol %, or at least 90 mol %, or at least 95 mol % of the cobalt as described above). In certain embodiments as otherwise described herein, the cobalt metal of the first activated catalyst comprises significant amounts of both fcc cobalt metal as well as hcp cobalt metal. In particular embodiments, the cobalt metal includes fcc cobalt metal and hcp cobalt metal present in a ratio in the range of 25:75 to 75:25.

The first activated catalyst is contacted with a mixture of hydrogen and carbon monoxide (the first gaseous reactant mixture) at a first reaction temperature (T_{R}1) of at least 180 °C and first reaction pressure (P_{R}1) of at least 10 bara to produce hydrocarbons for a first reaction time period of at least 24 hours.

The person of ordinary skill in the art can adapt conventional Fischer Tropsch process conditions for use in the process as described herein In certain embodiments of the Fischer-Tropsch processes of the disclosure, the volume ratio of hydrogen to carbon monoxide (H₂:CO) in the first gaseous reactant mixture is typically at least 1:1, preferably at least 1.1:1, more preferably at least 1.2:1, more preferably at least 1.3:1, more preferably at least 1.4:1, more preferably at least 1.5:1, or even at least 1.6:1. In some or all embodiments of the present invention, the volume ratio of hydrogen to carbon monoxide (H₂:CO) in the first gaseous reactant mixture is at most 5:1, preferably at most 3:1, most preferably at most 2.2:1. Examples of suitable volume ratios of hydrogen to carbon monoxide (H₂:CO) in the first gaseous reactant mixture include the ranges: from 1:1 to 5:1; from 1.1:1 to 3:1; from 1.2:1 to 3:1; from 1.3:1 to 2.2:1; from 1.4:1 to 5:1; from 1.4:1 to 3:1; from 1.4:1 to 2.2:1; from 1.5:1 to 3:1; from 1.5:1 to 2.2:1; and, from 1.6:1 to 2.2:1. The gaseous reactant stream may also comprise other gaseous components, such as nitrogen, carbon dioxide, water, methane and other saturated and/or unsaturated light hydrocarbons, each preferably being present at a concentration of less than 30% by volume.

The first reaction temperature (T_{R}1) is at least 180 °C, however a person of ordinary skill in the art can adapt conventional Fischer Tropsch temperatures for use in order to prepare hydrocarbons in accordance with the present disclosure. For example, the first reaction temperature may suitably be in the range from 180 to 400 °C, such as from 180 to 350 °C, 180 to 300 °C, or from 180 to 250 °C.

The first reaction pressure (P_{R}1) is at least 10 bara (bar absolute) (1 MPa), however a person of ordinary skill in the art can adapt conventional Fischer Tropsch pressures for use in order to prepare hydrocarbons in accordance with the present disclosure. For example, the first reaction pressure may suitably be in the range from 10 to 100 bara (from 1 to 10 MPa), such as from 15 to 75 bara (from 1.5 to 7.5 MPa), or from 20 to 50 bara (from 2.0 to 5.0 MPa).

In preferred embodiments, the first reaction temperature is in the range from 180 to 350 °C, more preferably from 180 to 300 °C, and most preferably from 200 to 260 °C. In preferred embodiments, the first reaction pressure is in the range from 10 to 100 bara (from 1 to 10 MPa), more preferably from 10 to 60 bara (from 1 to 6 MPa) and most preferably from 20 to 45 bara (from 2 to 4.5 MPa).

The first reaction time period is a time period of at least 24 hours. The first reaction time period may be up to six months, or even up to one year; typically, the first reaction time period will be at least 24 hours and at most 30 days, more typically at most 28 days, for example at most 21 days. In some or all embodiments, the first reaction time period is in the range of from 24 hours to 360 hours, for example from 24 to 240 hours, or from 24 to 168 hours.

The Fischer-Tropsch synthesis reaction may be performed in any suitable type of reactor, for example it may be performed in a fixed bed reactor, a slurry bed reactor, or a CANS reactor. CANS reactors, and associated containers suitable for use in the processes described herein, are described in WO 2011/048361, which is hereby incorporated herein by reference in its entirety for its disclosure of such canisters and uses thereof.

In typical Fischer-Tropsch processes, the first activated catalyst would not be subjected to a multi-step treatment after starting the production of hydrocarbons in-situ. Rather, in typical Fischer-Tropsch process, the process would be stopped and the first activated catalyst would be subjected to a decoking step (e.g., such as by a steam or oxidative treatment) before the process would begin again. Advantageously, the present inventors have found that a shut-down of the process and oxidation of the first activated catalyst is not necessary. Instead, an in-situ treatment of the catalyst can be used. As such, the present inventors have determined, that in-situ treatment of the catalyst can improve at least one aspect of the performance of the catalyst. In some or all embodiments of the present invention, the contacting of the first activated catalyst with the carbon monoxide rich stream happens without the catalyst being exposed to oxidizing conditions and without the temperature of the reactor falling below the first temperature (T1).

The treated catalyst is formed by contacting the first activated catalyst, after the first reaction period, with a carbon monoxide rich stream at a first temperature (T1) and a first pressure (P1). The treated catalyst will comprise cobalt in the form of cobalt carbide.

In certain embodiments as otherwise described herein, the carbon monoxide rich stream is carbon monoxide gas, CO. The carbon monoxide gas may be mixed with other gases, such as an inert carrier gas. Examples of such inert carrier gasses include nitrogen, carbon dioxide, argon, or helium. The carbon monoxide gas may also be mixed with hydrogen, with or without one or more additional carrier gasses. In certain embodiments, the carbon monoxide rich stream comprises hydrogen, wherein the hydrogen is present in an amount in the range of 0.1-10 vol %, e.g., 0.1-5 vol %, or 0.1-1 vol %. But in other embodiments, substantially no hydrogen is present (i.e., no more than 0.1 vol %). In certain embodiments, the formation of the treated catalyst is performed by contacting the treated catalyst with a carbon monoxide rich stream, wherein the carbon monoxide rich stream comprises at least 50 vol % CO (e.g., at least 60 vol %, or at least 70 vol %, or at least 80 vol %, or at least 90 vol %, or at least 95 vol %, or essentially 100 vol % CO). In particular embodiments, the carbon monoxide rich stream comprises at least 50 vol % CO (e.g., at least 60 vol %, or at least 70 vol %, or at least 80 vol %, or at least 90 vol %, or at least 95 vol %) and less than 10 vol % H₂ (e.g., in the range of 0.1-10 vol %, or in the range of 0.1-5 vol %, or in the range of 0.1-1 vol %., or no more than 0.1 vol %).

In certain other embodiments as otherwise described herein, the carbon monoxide rich stream is a synthesis gas, namely a mixture of carbon monoxide with hydrogen. In some embodiments, the carbon monoxide rich stream is a synthesis gas, wherein the volume ratio of hydrogen to carbon monoxide (H₂:CO) in such synthesis gas lower than that of the first gaseous reactant mixture, i.e., comprises more carbon monoxide on a volumetric ratio compared to the first gaseous reactant mixture. For example, the synthesis gas which may be used as the carbon monoxide rich stream can have a volume ratio of hydrogen to carbon monoxide (H₂:CO) of at most 1.5:1, such as at most 1.4:1, or at most 1.3:1, or at most 1.2:1, or at most 1.1:1, or at most 1:1. Examples of suitable volume ratios of hydrogen to carbon monoxide (H₂:CO) in the first gaseous reactant mixture include the ranges: from 0.5:1 to 1.5:1; from 0.5:1 to 1.4:1; from 0.5:1 to 1.3:1; from 0.5:1 to 1.2:1; from 0.5:1 to 1.1:1; from 0.5:1 to 1:1; from 0.7:1 to 1.5:1; from 0.7:1 to 1.4:1; from 0.7:1 to 1.3:1; from 0.7:1 to 1.2:1; from 0.7:1 to 1.1:1; from 0.7:1 to 1:1, from 0.8:1 to 1.5:1; from 0.8:1 to 1.4:1; from 0.8:1 to 1.3:1; from 0.8:1 to 1.2:1; from 0.8:1 to 1.1:1; from 0.8:1 to 1:1, from 0.9:1 to 1.5:1; from 0.9:1 to 1.4:1; from 0.9:1 to 1.3:1; from 0.9:1 to 1.2:1; from 0.9:1 to 1.1:1; from 0.9:1 to 1:1.

The formation of the treated catalyst is performed at a first pressure (P1) and a first temperature (T1), wherein P1 is at least 1 bara and at most 50 bara, and T1 is at most 300 °C. In certain embodiments as otherwise described herein, the P1 is in the range of from 1 bara to at most 10 bara, in other embodiments as otherwise described herein, P1 is at least 5 bara, preferably in the range of from 5 bara to 50 bara. Examples of suitable ranges for P1 include 1-10 bara, or 2-10 bara, or 2-10 bara, or 3-10 bara, or 4-10 bara, or 5-10 bara, or 5-30 bara, or 5-25 bara, or 7-50 bara, or 7-30 bara, or 7-25 bara, or 10-50 bara, or 7-30 bara, or 7-25 bara, or 10-50 bara, or 10-30 bara, or 10-25 bara. The carbon monoxide rich stream can be provided at a variety of concentrations in a process gas, e.g., at least 5 vol %, e.g., at least 25 vol %, at least 50 vol %, or at least 75 vol %; the process gas can further include, e.g., inert gases such as nitrogen. In certain embodiments, the T1 is in the range of 25 °C to 250 °C, e.g., 50 °C to 225 °C. For example, in particular embodiments, the T1 is in the range of 25 °C to 200 °C, or 75 °C to 200 °C, or 100 °C to 200 °C, or 125 °C to 200 °C. In particular embodiments, T1 is about 200 °C. In other embodiments, the T1 is no more than 150 °C, or no more than 100 °C. For example, in certain embodiments, T1 is in the range of 25 °C to 150 °C, e.g., 50 °C to 125 °C, or 50 °C to 100 °C. Advantageously, the present inventors have found that formation of the treated catalyst can be conducted in-situ and without a shut-down of the Fischer-Tropsch process. By forming the first treated catalyst in-situ, the temperature of the process can be maintained. For example, in some or all embodiments as described herein, the first temperature (T1) is within 100 °C of the first reaction temperature (T_{R}1), e.g., within 50 °C of the first reaction temperature (T_{R}1), or within 25 °C of the first reaction temperature (T_{R}1). In some or all embodiments, the first pressure (P1) is within 30 bara of the first reaction pressure (P_{R}1), e.g., within 20 bara of the first reaction pressure (P_{R}1), or within 10 bara of the first reaction pressure (P_{R}1).

The contacting of the first activated catalyst with a carbon monoxide rich stream at a first temperature (T1) and a first pressure (P1) will be for a time period sufficient for at least some of the cobalt on the first activated catalyst to form cobalt carbide to provide the treated catalyst. In some or all embodiments, the treated catalyst substantially lacks cobalt oxides (e.g., CoO, Co₂O₃, or Co₃O₄) and/or cobalt hydroxides (e.g., Co(OH)₂ or Co(OH)₃). The contacting of the first activated catalyst with a carbon monoxide will typically occur for a time period of at least 1 hour, typically, the time period for contacting of the first activated catalyst with a carbon monoxide will be at most 168 hours. Typically, the time period for contacting of the first activated catalyst with a carbon monoxide will be at least 1 hours and at most 168 hours, more typically at least 2 hours and at most 96 hours, for example at least 2 hours and at most 48 hours, or at least 2 hours and at most 36 hours, or at least 2 hours and at most 24 hours, or at least 2 hours and at most 12 hours, or at least 2 hours and at most 8 hours.

The treated catalyst is then contacted with a hydrogen rich stream at a second temperature (T2) and a second pressure (P2) to form a second activated catalyst.

Notably, the hydrogen rich stream may be selected to efficiently convert a portion, or the entirety, of the cobalt carbide formed during the formation of the treated catalyst to cobalt metal.

In certain embodiments as otherwise described herein, the hydrogen rich stream is hydrogen gas, H₂. The hydrogen gas may be mixed with other gases, such as an inert carrier gas. Examples of such inert carrier gasses include nitrogen, carbon dioxide, argon, or helium. The hydrogen gas may also be mixed with carbon monoxide, with or without one or more additional carrier gasses. In certain embodiments, the hydrogen rich stream comprises carbon monoxide, wherein the carbon monoxide is present in an amount in the range of 0.1-10 vol %, e.g., 0.1-5 vol %, or 0.1-1 vol %. But in other embodiments, substantially no carbon monoxide is present (i.e., no more than 0.1 vol %). In certain embodiments, the formation of the second activated catalyst is performed by contacting the treated catalyst with a hydrogen rich stream, wherein the hydrogen rich stream comprises at least 50 vol % H₂ (e.g., at least 60 vol %, or at least 70 vol %, or at least 80 vol %, or at least 90 vol %, or at least 95 vol %, or essentially 100 vol % H₂). In particular embodiments, the formation of the second activated catalyst is performed by contacting the treated catalyst with a hydrogen rich stream, wherein the hydrogen rich stream comprises at least 50 vol % H₂ (e.g., at least 60 vol %, or at least 70 vol %, or at least 80 vol %, or at least 90 vol %, or at least 95 vol %) and less than 10 vol % CO (e.g., in the range of 0.1-10 vol %, or in the range of 0.1-5 vol %, or in the range of 0.1-1 vol %., or no more than 0.1 vol %).

The formation of the second activated catalyst is performed at a second temperature (T2) and a second pressure (P2). The second temperature is less than 300 °C. In certain embodiments as otherwise described herein, the second temperature is in the range of 150 °C to less than 300 °C. In certain embodiments, the second temperature is in the range of 150-290 °C, or 150-280 °C, or 150-270 °C, or 180-300 °C, or 180-290 °C, or 180-280 °C, or 180-270 °C, or 200-300 °C, or 200-290 °C, or 200-280 °C, or 200-270 °C. The formation of the second activated catalyst can advantageously be accomplished in-situ and the temperature and pressure of the previous step of the process can be maintained. For example, in some or all embodiments as described herein, the second temperature (T2) is within 100 °C of the first temperature (T1), e.g., within 50 °C of the first temperature (T1), or within 25 °C of the first temperature (T1). In some or all embodiments, T2 is at most 100 °C greater than T1, for example T2 is at most 90 °C greater than T1, or T2 is at most 70 °C greater than T1.

The second pressure is at least 10 bara (1 MPa). In certain embodiments as otherwise described herein, P2 is in the range of at least 1 bara and at most 50 bara. In certain embodiments as otherwise described herein, the P2 is at least 5 bara, preferably in the range of from 10 bara to 50 bara, e.g., 10-30 bara, or 10-25 bara, or 12-50 bara, or 12-30 bara, or 12-25 bara, or 15-50 bara, or 15-30 bara, or 15-25 bara, or 15-50 bara, or 15-30 bara, or 15-25 bara. In some or all embodiments, the second pressure (P2) is within 30 bara of the first pressure (P1), e.g., within 20 bara of the first pressure (P1), or within 10 bara of the first pressure (P1).

The formation of the second activated catalyst can be performed for a time and under conditions sufficient to provide the desired degree of reduction as described above. The contacting of the treated catalyst with the hydrogen rich stream will typically occur for a time period of at least 1 hour, typically, the time period for contacting of the treated catalyst with the hydrogen rich stream will be at most 168 hours. Typically, the time period for contacting the treated catalyst with the hydrogen rich stream will be at least 1 hours and at most 168 hours, more typically at least 2 hours and at most 96 hours, for example at least 2 hours and at most 48 hours, or at least 2 hours and at most 36 hours, or at least 2 hours and at most 24 hours, or at least 2 hours and at most 12 hours, or at least 2 hours and at most 8 hours.

In some or all embodiments, the second activated catalyst substantially lacks cobalt oxides (e.g., CoO, Co₂O₃, or Co₃O₄) and/or cobalt hydroxides (e.g., Co(OH)₂ or Co(OH)₃).

Once generated, the second activated catalyst is contacted with a mixture of hydrogen and carbon monoxide (the second gaseous reactant mixture) at a second reaction temperature (T_{R}2) of at least 180 °C and second reaction pressure (P_{R}2) of at least 10 bara to produce hydrocarbons.

Similarly to the first reaction time period, the person of ordinary skill in the art can adapt conventional Fischer Tropsch process conditions for use in the process as described herein In certain embodiments of the Fischer-Tropsch processes of the disclosure, the volume ratio of hydrogen to carbon monoxide (H₂:CO) in the second gaseous reactant mixture is typically at least 1:1, preferably at least 1.1:1, more preferably at least 1.2:1, more preferably at least 1.3:1, more preferably at least 1.4:1, more preferably at least 1.5:1, or even at least 1.6:1. In some or all embodiments of the present invention, the volume ratio of hydrogen to carbon monoxide (H₂:CO) in the second gaseous reactant mixture is at most 5:1, preferably at most 3:1, most preferably at most 2.2:1. Examples of suitable volume ratios of hydrogen to carbon monoxide (H₂:CO) in the second gaseous reactant mixture include the ranges: from 1:1 to 5:1; from 1.1:1 to 3:1; from 1.2:1 to 3:1; from 1.3:1 to 2.2:1; from 1.4:1 to 5:1; from 1.4:1 to 3:1; from 1.4:1 to 2.2:1; from 1.5:1 to 3:1; from 1.5:1 to 2.2:1; and, from 1.6:1 to 2.2:1. The gaseous reactant stream may also comprise other gaseous components, such as nitrogen, carbon dioxide, water, methane and other saturated and/or unsaturated light hydrocarbons, each preferably being present at a concentration of less than 30% by volume.

The second reaction temperature (T_{R}2) is at least 180 °C, however a person of ordinary skill in the art can adapt conventional Fischer Tropsch temperatures for use in order to prepare hydrocarbons in accordance with the present disclosure. For example, the second temperature of the reaction may suitably be in the range from 180 to 400 °C, such as from 180 to 350 °C, 180 to 300 °C, or from 180 to 250 °C. As described above, the present inventors have found that the treatment step can be conducted in-situ and the temperature of the process can be maintained. For example, in some or all embodiments as described herein, the second reaction temperature (T_{R}2) is within 100 °C of the second temperature (T2), e.g., within 50 °C of the second temperature (T2), or within 25 °C of the second temperature (T2).

The second reaction pressure (P_{R}2) is at least 10 bara (bar absolute) (1 MPa), however a person of ordinary skill in the art can adapt conventional Fischer Tropsch pressures for use in order to prepare hydrocarbons in accordance with the present disclosure. For example, the second reaction pressure may suitably be in the range from 10 to 100 bara (from 1 to 10 MPa), such as from 15 to 75 bara (from 1.5 to 7.5 MPa), or from 20 to 50 bara (from 2.0 to 5.0 MPa). As with the temperature, the second reaction pressure can be maintained from the previous step. In some or all embodiments, the second reaction pressure (P_{R}2) is within 30 bara of the second pressure (P2), e.g., within 20 bara of the second pressure (P2), or within 10 bara of the second pressure (P2).

In preferred embodiments, the second reaction temperature is in the range from 180 to 350 °C, more preferably from 180 to 300 °C, and most preferably from 200 to 260 °C. In preferred embodiments, the second reaction pressure is in the range from 10 to 100 bara (from 1 to 10 MPa), more preferably from 10 to 60 bara (from 1 to 6 MPa) and most preferably from 20 to 45 bara (from 2 to 4.5 MPa).

The person of ordinary skill in the art can adapt conventional FT processes for use of the catalyst materials described herein In certain embodiments of the Fischer-Tropsch processes of the disclosure, the volume ratio of hydrogen to carbon monoxide (H₂:CO) in the gaseous reactant mixture is typically at least 1:1, preferably at least 1.1:1, more preferably at least 1.2:1, more preferably at least 1.3:1, more preferably at least 1.4:1, more preferably at least 1.5:1, or even at least 1.6:1. In some or all embodiments of the present invention, the volume ratio of hydrogen to carbon monoxide (H₂:CO) in the gaseous reactant mixture is at most 5:1, preferably at most 3:1, most preferably at most 2.2:1. Examples of suitable volume ratios of hydrogen to carbon monoxide (H₂:CO) in the gaseous reactant mixture include the ranges: from 1:1 to 5:1; from 1.1:1 to 3:1; from 1.2:1 to 3:1; from 1.3:1 to 2.2:1; from 1.4:1 to 5:1; from 1.4:1 to 3:1; from 1.4:1 to 2.2:1; from 1.5:1 to 3:1; from 1.5:1 to 2.2:1; and, from 1.6:1 to 2.2:1. The gaseous reactant stream may also comprise other gaseous components, such as nitrogen, carbon dioxide, water, methane and other saturated and/or unsaturated light hydrocarbons, each preferably being present at a concentration of less than 30% by volume.

Conventional Fischer-Tropsch temperatures may be used in order to prepare optionally oxygenated hydrocarbons in accordance with the present disclosure. For example, the temperature of the reaction may suitably be in the range from 100 to 400 °C, such as from 150 to 350 °C, or from 150 to 250 °C. The pressure of the reaction may suitably be in the range from 10 to 100 bar (from 1 to 10 MPa), such as from 15 to 75 bar (from 1.5 to 7.5 MPa), or from 20 to 50 bar (from 2.0 to 5.0 MPa).

In preferred embodiments, the temperature of the Fischer-Tropsch reaction is in the range from 150 to 350 °C, more preferably from 180 to 300 °C, and most preferably from 200 to 260 °C. In preferred embodiments, the pressure of the Fischer-Tropsch reaction is in the range from 10 to 100 bar (from 1 to 10 MPa), more preferably from 10 to 60 bar (from 1 to 6 MPa) and most preferably from 20 to 45 bar (from 2 to 4.5 MPa).

The process as described herein is performed sequentially.

In another embodiment of the present invention, there is provided a process for converting a mixture of hydrogen and carbon monoxide to a hydrocarbon composition comprising one or more optionally oxygenated hydrocarbons, the process consisting of the following steps:
(a) providing a catalyst material comprising cobalt disposed on a support;
(b) reducing the catalyst material at a temperature of at most 300 °C to form the first activated catalyst;
(c) contacting the first activated catalyst with a mixture of hydrogen and carbon monoxide at a first reaction temperature (T_{R}1) of at least 180 °C and first reaction pressure (P_{R}1) of at least 10 bara to produce hydrocarbons for a first reaction time period of at least 24 hours;
(d) after the first reaction time period, contacting the first activated catalyst with a carbon monoxide rich stream at a first pressure (P1) and a first temperature (T1) to provide a treated catalyst, wherein P1 is at least 1 bara and at most 50 bara, and T1 is at most 300 °C;
(e) contacting the treated catalyst with a hydrogen rich stream at a second temperature (T2) and a second pressure (P2) to form a second activated catalyst, wherein P2 is at least 10 bara and wherein T2 is less than 300 °C; and
(f) contacting the second activated catalyst with a mixture of hydrogen and carbon monoxide at a second reaction temperature (T_{R}2) of at least 180 °C and second reaction pressure (P_{R}2) of at least 10 bara to produce hydrocarbons.

The hydrocarbon composition produced from the mixture of hydrogen and carbon monoxide can vary based on changes in process conditions as known in the art. In certain embodiments, the hydrocarbon composition comprises hydrocarbons (e.g., linear hydrocarbons, branched hydrocarbons, saturated or unsaturated hydrocarbons) and oxygenated derivatives thereof. Examples of the oxygenated derivatives thereof include hydrocarbons with one or more functional group of alcohols, aldehydes, ketones, carboxylic acids, esters, and combinations thereof. In certain embodiments as otherwise described herein, the hydrocarbon composition comprises at least one of alkanes, alkenes, and alcohols.

Another aspect of the present disclosure is the use of an in-situ catalyst treatment process as described herein to increase the selectivity of the conversion of carbon monoxide and hydrogen to hydrocarbons having five or more carbon atoms (C5+), compared to a catalyst which has not been subjected to such an in-situ catalyst treatment process.

Another aspect of the present disclosure is the use of an in-situ catalyst treatment process as described herein to increase the conversion of carbon monoxide and hydrogen to hydrocarbons compared to a catalyst which has not been subjected to such an in-situ catalyst treatment process.

Since the use of an in-situ catalyst treatment process as described herein increases the productivity of the catalyst in Fischer-Tropsch reactions, this enables a the person of ordinary skill in the art to decrease the reaction temperature to achieve the same conversion of carbon monoxide and hydrogen to hydrocarbons compared to a catalyst which has not been subjected to such an in-situ catalyst treatment process, and hence another aspect of the present disclosure is the use of a catalyst treatment process as described herein to increase the catalyst life of the catalyst.

### EXAMPLES

The Examples that follow are illustrative of specific embodiments of the methods of the disclosure, and various uses thereof. They are set forth for explanatory purposes only, and are not to be taken as limiting the scope of the disclosure.

The Fischer-Tropsch catalyst was prepared by impregnation of a titania support with cobalt nitrate hexahydrate, manganese acetate tetrahydrate, followed by drying and calcination at 300 °C. The catalysts contained, after reduction, cobalt in an amount of 10% by weight and manganese in an amount of 1% by weight.

The catalysts were activated and treated in accordance with the appropriate listed H₂ and CO conditions as detailed below. A Fischer-Tropsch reaction was performed through contacting the respective catalyst with a 1.8 H₂:CO in N₂ at 30 barg and 8795 hr-1 syngas gas hourly space velocity. The tests were completed on a high throughput multichannel reactor with 1 g of catalyst using common gas feeds and pressure, with varying applied temperatures. The catalysts were initially dried in nitrogen at 120 °C before the initial activation.

TABLE 1

| | Intial | | [symbol] | |
|---|---|---|---|---|
| | Activation | | Reaction | CO |
| | Temp | | temp | Conversion |
| Example | [symbol] * | Treatment | (°C) | (%) |
| A** | 300 | n/a | 203 | 35.8 |
| B-A** | 300 | Performance after activation but | 207 | 39.3 |
| | | before treatment | | |
| B-B** | 300 | (i) 50% CO in N₂, 2000 hr⁻¹, | 207 | 35.3 |
| B-C**/*** | 300 | 10 barg, 12 hours, 230 °C | 207 | 35.7 |
| | | (ii) 50% H₂, 4300 hr⁻¹, 30 barg, | | |
| | | 12 hours, 210 °C | | |
| 1A | 270 | Performance after activation but | 207 | 36.2 |
| | | before treatment | | |
| 1B | 270 | (i) 50% CO in N₂, 2000 hr⁻¹, | 207 | 39.0 |
| 1C*** | 270 | 10 barg, 12 hours, 230 °C | 205 | 35.3 |
| | | (ii) 50% H₂, 4300 hr⁻¹, 30 barg, | | |
| | | 12 hours, 210 °C | | |
| 2A | 250 | Performance after activation but | 209 | 35.2 |
| | | before treatment | | |
| 2B | 250 | (i) 50% CO in N₂, 2000 hr⁻¹, | 209 | 41.5 |
| 2C*** | 250 | 10 barg, 12 hours, 230 °C | 206 | 35.8 |
| | | (ii) 50% H₂, 4300 hr⁻¹, 30 barg, | | |
| | | 12 hours, 210 °C | | |
| 3A | 240 | Performance after activation but | 210 | 35.3 |
| | | before treatment | | |
| 3B | 240 | (i) 50% CO in N₂, 2000 hr⁻¹, | 210 | 43.2 |
| 3C*** | 240 | 10 barg, 12 hours, 230 °C | 207 | 36.2 |
| | | (ii) 50% H₂, 4300 hr⁻¹, 30 barg, | | |
| | | 12 hours, 210 °C | | |

*Initial activation performed under 100% H₂, 0 barg, 5000 hr⁻¹, 24 hours.
**Comparative example.
***Reaction temperature adjusted to provide approximately the same conversion is the catalyst before treatment. [symbol]
indicates data missing or illegible when filed

TABLE 2

| | | | | CO | CO |
|---|---|---|---|---|---|
| | Initial | | | Conversion | Conversion |
| | Activation | | Reaction | before | after |
| | Temp | | temp | treatment | treatment |
| Example | (°C)* | Treatment | (°C) | (%) | (%) |
| C** | 300 | n/a | 205 | 30.3 | 28.4 |
| 4 | 270 | (i) 50% CO in N₂, | 205 | 32.4 | 32.7 |
| 5 | 240 | 2000 hr⁻¹, 10 barg, | 205 | 22.8 | 30.6 |
| | | 24 hours, 210 °C | | | |
| | | (ii) 50% H₂, 4300 hr⁻¹ | | | |
| | | 30 barg, 24 hours, | | | |
| | | 240 °C | | | |

*Initial activation performed under 50% H₂ in N₂, 16 barg, 4300 hr⁻¹, 24 hours.
**Comparative example.

TABLE 3

| | Initial | | Time | | | | | |
|---|---|---|---|---|---|---|---|---|
| | Activation | | on | Reaction | CO | | | |
| | Temp | | stream | temp | Conversion | Selectivity | Selectivity | Selectivity |
| Example | (°C)* | Treatment | (hours) | (°C) | (%) | CH4 | C2-C4 | C5+ |
| D** | 300 | n/a | 160 | 205 | 34.8 | 5.1 | 6.7 | 88.2 |
| E** | 250 | 50% CO in N₂, 2000 hr^{-1,} | 400 | 205 | 19.8 | 4.5 | 5.4 | 90.1 |
| | | 10 barg, 24 hours, 230 °C | | | | | | |
| | | (no subsequent treatment | | | | | | |
| | | with hydrogen rich stream) | | | | | | |

*Initial activation performed under 50% H₂ in N₂, 16 barg, 4300 hr⁻¹, 24 hours.
**Comparative example.

As can be seen from the results presented in Table 1 above, the examples which comprised the treatment resulted in a significantly improved performance in conversion of CO at a given applied temperature and an improved selectivity to C5+ hydrocarbons when the temperature was adjusted to provide comparable CO conversion to the CO conversion before the treatment was performed.

As can be seen from the results presented in Table 2 above, the conversion of CO after the treatment was performed is greater when a lower initial reduction temperature is applied.

As can be seen from the results presented in Table 3 above, the treatment of the catalyst with just a carbon monoxide rich stream without a subsequent treatment with a hydrogen rich stream did not result in an increased conversion of CO after treatment.

The particulars shown herein are by way of example and for purposes of illustrative discussion of certain embodiments of the present disclosure only and are presented in the cause of providing what is believed to be the most useful and readily understood description of the principles and conceptual aspects of various embodiments of the disclosure. In this regard, no attempt is made to show details associated with the methods of the disclosure in more detail than is necessary for the fundamental understanding of the methods described herein, the description taken with the examples making apparent to those skilled in the art how the several forms of the methods of the disclosure may be embodied in practice. Thus, before the disclosed processes and devices are described, it is to be understood that the aspects described herein are not limited to specific embodiments, apparatus, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the methods of the disclosure (especially in the context of the following embodiments and claims) are to be construed to cover both the singular and the plural, unless otherwise indicated herein or clearly contradicted by context.

All methods described herein can be performed in any suitable order of steps unless otherwise indicated herein or otherwise clearly contradicted by context. The use of any and all examples, or exemplary language (e.g., “such as”) provided herein is intended merely to better illuminate the methods of the disclosure and does not pose a limitation on the scope of the disclosure. No language in the specification should be construed as indicating any non-claimed element essential to the practice of the methods of the disclosure.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

All percentages, ratios and proportions herein are by weight, unless otherwise specified.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the disclosure are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of various aspects of the disclosure are described herein, including the best mode known to the inventors for carrying out the methods described herein. Of course, variations on these described embodiments will become apparent to those of ordinary skill in the art upon reading the foregoing description. The skilled artisan will employ such variations as appropriate, and as such the methods of the disclosure can be practiced otherwise than specifically described herein. Accordingly, the scope of the disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The phrase “at least a portion” as used herein is used to signify that, at least, a fractional amount is required, up to the entire possible amount.

In closing, it is to be understood that the various embodiments herein are illustrative of the methods of the disclosures. Other modifications that may be employed are within the scope of the disclosure. Thus, by way of example, but not of limitation, alternative configurations of the methods may be utilized in accordance with the teachings herein. Accordingly, the methods of the present disclosure are not limited to that precisely as shown and described.

1. A process for converting a mixture of hydrogen and carbon monoxide to a hydrocarbon composition comprising one or more optionally oxygenated hydrocarbons, the process comprising the following steps:
(a) providing a catalyst material comprising cobalt disposed on a support;
(b) reducing the catalyst material at a temperature of below 300 °C to form the first activated catalyst;
(c) contacting the first activated catalyst with a mixture of hydrogen and carbon monoxide at a first reaction temperature (T_{R}1) of at least 180 °C and first reaction pressure (P_{R}1) of at least 10 bara to produce hydrocarbons for a first reaction time period of at least 24 hours;
(d) after the first reaction time period, contacting the first activated catalyst with a carbon monoxide rich stream at a first pressure (P1) and a first temperature (T1) to provide a treated catalyst, wherein P1 is at least 1 bara and at most 50 bara, and T1 is at most 300 °C;
(e) contacting the treated catalyst with a hydrogen rich stream at a second temperature (T2) and a second pressure (P2) to form a second activated catalyst, wherein P2 is at least 10 bara and wherein T2 is less than 300 °C; and
(f) contacting the second activated catalyst with a mixture of hydrogen and carbon monoxide at a second reaction temperature (T_{R}2) of at least 180 °C and second reaction pressure (P_{R}2) of at least 10 bara to produce hydrocarbons.

2. The process of claim 1, wherein the catalyst material comprises cobalt in the range of 5 wt % to 35 wt %, on an elemental basis.

3. The process of claim 1, wherein the catalyst material further comprises manganese, ruthenium or rhenium.

4. The process of claim 1, wherein the reducing the catalyst material to form the first activated catalyst in step (b) is performed using a reducing gas which comprises at least 50 vol % H₂.

5. The process of claim 1, wherein the reducing the catalyst material to form the first activated catalyst in step (b) is performed at a temperature in the range of from 200 °C to 300 °C.

6. The process of claim 1, wherein the first pressure (P1) in the range of from 1 bara to 10 bara.

7. The process of claim 1, wherein the first pressure (P1) in the range of from 5 bara to 30 bara.

8. The process of claim 1, wherein the first temperature (T1) is in the range of from 25 °C to 260 °C.

9. The process of claim 1, wherein the carbon monoxide rich stream comprises at least 50 vol % CO and less than 10 vol % H₂.

10. The process of claim 1, wherein the carbon monoxide rich stream is synthesis gas having a volume ratio of hydrogen to carbon monoxide (H₂:CO) of at most 1.5:1.

11. The process of claim 10, wherein the volume ratio of hydrogen to carbon monoxide (H₂:CO) in the synthesis gas is lower than the volume ratio of hydrogen to carbon monoxide of the mixture of hydrogen and carbon monoxide used in step (c).

12. The process of claim 10, wherein the reducing the catalyst material to form the first activated catalyst in step (b) is performed at a temperature in the range of from in the range of 220 °C to 280 °C.

13. The process of claim 1, wherein the second temperature (T2) is in the range of 180 °C to 290 °C.

14. The process of claim 1, wherein the hydrogen rich stream comprises at least 50 vol % H₂ and less than 10 vol % CO.

15. The process of claim 1, wherein the first reaction time period is in the range of from 24 hours to 360 hours.
